(19) United States
(12) Patent Application Publication
(10) Pub. No.: US 2007/0005515 A1
(43) Pub. Date: Jan. 4, 2007

(54) System and method for providing secure transactions

(76) Inventor: Jonathan B. Rosenberg, Auburndale, MA (US)

Correspondence Address: WILMER CUTLER PICKERING HALE AND DORR LLP, 60 STATE STREET, BOSTON, MA, 02109, US

(21) Appl. No.: 10/471,701

(22) PCT Filed: Mar. 12, 2002
(86) PCT No.: PCT/US02/07657

§ 371 Date: May 15, 2006

Related U.S. Application Data
(60) Provisional application No. 60/275,074, filed on Mar. 12, 2001.

(51) Int. Cl. G06Q 99/00

(52) U.S. Cl. 705/76

(57) ABSTRACT

The present invention is a method and system for providing a user with confirmation of the identity of a transaction partner comprising the steps of gathering a plurality of business credentials for at least one transaction partner having significance to a defined customer, indexing the business credentials for an electronic database, evaluating the value of each of the business credentials to the defined customer, providing electronic access to the database and generating at least one report summarizing the business credentials of the at least one transaction partner.

### RELATED APPLICATIONS AND CLAIM OF PRIORITY

This application claims the benefit of and incorporates in its entirety herein by reference the contents of the following co-pending application: Application No. 60/275,074 filed Mar. 12, 2001, entitled “Safe Market”. This application is related to and incorporates in its entirety herein by reference the contents of the following co-pending application: application Ser. No. 10/039,986 filed Jan. 4, 2002 entitled “Web Site Identity Assurance”.

### COPYRIGH TRADEMARK NOTICE

At least one portion of this disclosure including any accompanying Appendix contains material, which is subject to copyright/trademark protection. The copyright/trademark owner has no objection to the facsimile reproduction by anyone of the patent document or the patent disclosure, as it appears in the U.S. Patent and Trademark Office patent files or records, but otherwise reserves all copyright/trademark rights whatsoever.

### BACKGROUND OF THE INVENTION

The importance of secure communication is increasing as world-wide networks such as the Internet and the World Wide Web (WWW) portion of the Internet expand. As global networks expand through the interconnection of existing networks, users may gain access to an unprecedented number of services. The services, each of which may be maintained by a different provider, give users access to academic, business, consumer, and government information. Service providers are now able to make their services available to an ever-expanding user base that is truly global.

The ease with which services and users are able to find each other and the convenience associated with on-line transactions is leading to an increase in the number of remote business and related transactions. However, users and services are not always certain who or what is at the other end of a transaction. Therefore, before they engage in business and other transactions, users and services want and need reassurance that each entity with whom they communicate is who or what it purports to be. For example, users will not be willing to make on-line purchases that require them to reveal their credit card numbers unless they are confident that the service with which they are communicating is in fact the service they wanted to access. Commercial and other private entities who provide on-line services may be more reluctant than individuals to conduct business on-line unless they are confident the communication is with the desired individual or service. From the small and/or new on-line merchant's standpoint, they can reach a global audience through the World Wide Web but they are usually unknown to potential customers and have no brand on which to build an on-line business. For them, displaying confirmed and trusted identity and legitimacy are critical to building their brand and business.

Both users and services need reassurance that neither will compromise the integrity of the other nor that confidential information will be revealed unintentionally to third parties while communications are occurring. Security in a global network, however, may be difficult to achieve for several reasons. First, the connections between remote users and services are dynamic. With the use of portable devices, users may change their remote physical locations frequently. The individual networks that comprise the global networks have many entry and exit points. Also, packet switching techniques used in global networks result in numerous dynamic paths that are established between participating entities in order to achieve reliable communication between two parties. Finally, communication is often accomplished via inherently insecure facilities such as the public telephone network and many private communication facilities. Secure communication is difficult to achieve in such distributed environments because security breaches may occur at the remote user's site, at the service computer site, or along the communication link. Consequently, reliable two-way authentication of users and the services is essential for achieving security in a distributed environment. This invention allows electronic marketplaces and similar Internet media of commercial interaction to implement key business trust services quickly and cost effectively. Global B2B trade is moving on-line, and with the move to on-line B2B transactions there is required the build out of infrastructure needed to support these electronic markets and other media. A core component of that B2B infrastructure revolves around identity. While the Internet represents a large business opportunity with its global scope and reach and even a leveling of the playing field for small and medium businesses, it is also devoid of identity. No relationship so critical for any business to be transacted can exist without identity. The present invention can fill this void and solve on-line identity problems by providing an repository of global business profiles that are used for authentication, permissions management and due diligence. Transaction participants will need to know whom they are trading with; and/or be able to confirm the identity of the business, and be able to attach a legal trail (digital signature) to those identities. Furthermore, financial and insurance service providers will require positive confirmation of a business's identity, the identity of their representatives and proof of authorization before they even consider submitting the transaction to underwriting. Identity management is one of the foundational elements in establishing and maintaining a trade relationship

### OBJECT OF THE PRESENT INVENTION

Accordingly, an object of the present invention is to provide the confirmed on-line identity and related business information within an electronic marketplace or other on-line or Web-based commercial method of exchange.

It is a further object of the present invention to provide the confirmed on-line identity and related business information in a standard, recognizable, easy-to-access package.

It is a further object of the present invention to provide current confirmation that identity and business information is valid and accurate.

### SUMMARY OF THE INVENTION

The invention described herein provides comprehensive business information, online, to participants in an electronic marketplace or other on-line or Web-based commercial method of exchange during a transaction. Accomplishing that task begins with tying a business representative's identity to a piece of content such as a bid, offer, Web site or page, or or RFP via a cryptographic digital signing process.

Digital signatures are only as worthwhile as the level of authentication that occurs when a signature key is issued to the company representative. An administrator authenticates the representative's authority and issues the representative a key that is used for signing. In addition, transaction authorization rules are set up for the representative by his/her company's designated trust administrator, who determines such things as the individual participant's transaction limits, authorized and marketplaces. When a representative of a business puts content into an electronic marketplace and digitally signs it, that representative should have the authority to make the commitment.

When a business enrolls for the services provided by the present invention, a trust administrator is appointed and both the company and trust administrator go through a rigorous process of identity authentication to determine that the business is valid and that the business provides its trust administrator with the authority act as the trust administrator. Once the trust administrator is authenticated, in one embodiment he/she can be issued an encrypted key, which for example could allow him/her to add authorized company representative who can participate in enabled marketplaces, although. The trust administrator is also authorized to disclose information about the company to form its trust profile. Disclosed information includes business demographics, confidentiality policies and standard business practices. The self-disclosed information is combined with third-party data, which includes initial authentication data, transaction partners' feedback and historical transaction data to develop a comprehensive picture of the business entity. The information gathered to develop this profile is organized around a trust model according to the present invention. The trust model is a dynamic method for determining the requirements for on-line trust based on a business' situational context such as vertical market, country of origin, etc.

When the digitally signed content is viewed, the system of the present invention can verify that it has not been changed, and the corresponding business entity's information is made available.

Content that has been signed can be stored locally. A business can subscribe to an additional service of the present invention to provide secure storage and reporting for content that a business has signed or viewed in an enabled marketplace. Content signing, in the context of a B2B marketplace, represents making a commitment of some type such as an offer to sell or bid to buy.

The present invention is a system and method that meets the needs set out above. More particularly, the present invention is a method and system for providing a user with confirmation of the identity of a transaction partner comprising the steps of gathering a plurality of business credentials for at least one transaction partner having significance to a defined customer, indexing the business credentials for an electronic database, evaluating the value of each of the business credentials to the defined customer, providing electronic access to the database and generating at least one report summarizing the business credentials of the at least one transaction partner. The present invention is also a method and system for providing related goods, services, and benefits to promote the transaction, such as warranties and insurance as to identity of the trading partner and traditional related goods and services such as financing, letters of credit, transaction-related insurance, transportation services, and the like.

### BRIEF DESCRIPTION OF THE DRAWINGS

Preferred embodiments of the present invention will now be described, by way of example only, with reference to the accompanying drawings in which:

FIG. 1 depicts an exemplary diagram of a network system on which the present invention may be implemented.

FIG. 2 depicts an exemplary graphical user interface of a Web Browser.

FIG. 3 depicts a block diagram of the identity confirmation data flow.

FIG. 4 depicts the multiple layers of identity confirmation data compilation.

FIG. 5 depicts a block diagram showing the digital signing process according to the present invention.

FIG. 6 depicts a block diagram showing the credential display process according to the present invention.

FIG. 7 depicts a block diagram showing the registration switch process according to the present invention.

FIG. 8 depicts a block diagram of the data extraction according to the present invention.

FIG. 9 depicts a block diagram of the data objects according to the present invention.

FIG. 10 depicts a block diagram of a user data flow compilation according to the present invention.

### DETAILED DESCRIPTION OF THE PREFERRED EMBODIMENT OF THE INVENTION

The present invention will now be described in detail with reference to the accompanying drawings. While the present invention is described in the context of an Internet based data communications network, which includes a specific number and type of components, the system of the present invention may be incorporated into data communications networks of many structures and sizes (e.g. mobile networks). The drawings are intended to provide one example of a data communication network configuration in which a system of the present invention may be implemented and are not intended to limit the applicability of the present invention to other network configurations.

The following description of the preferred embodiments of the invention relates to Web pages. It is noted up front, however, that the invention is not limited to use with Web pages. Rather, all aspects of the invention can be used with any computer generated content including, but not limited to, rows in a database, an entire database, computer generated queries, documents, and the like.

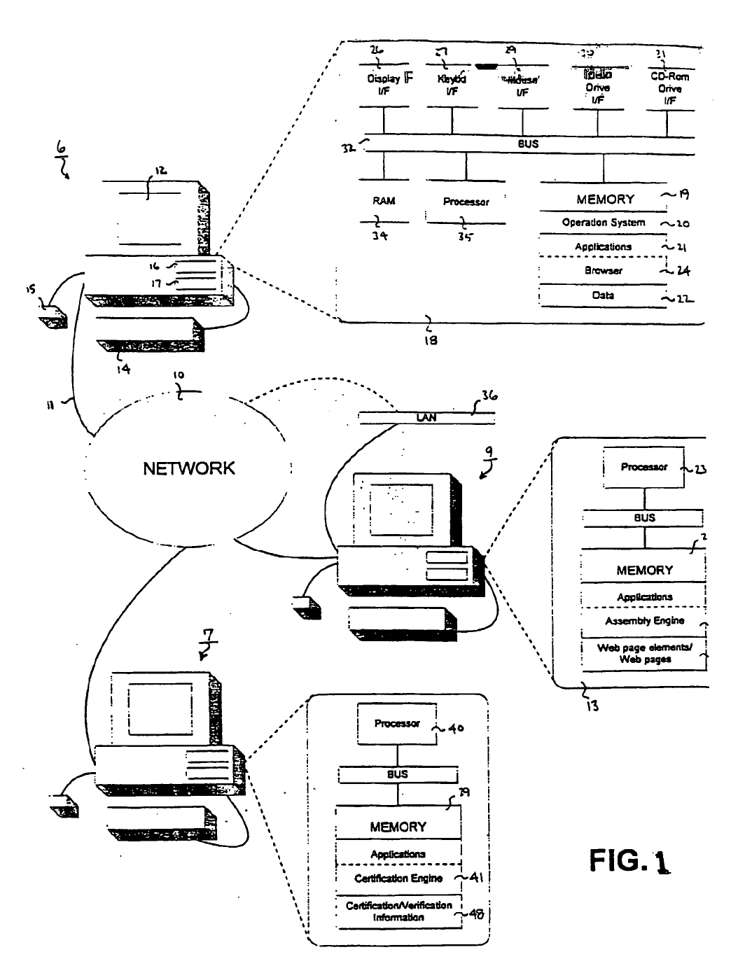

The present invention is preferably implemented using a client server architecture, such as that shown in FIG. 1. This architecture includes client 6, certification server 7, and Web server 9 connected via network 10. Network 10 may comprise any type of network or communications medium, including, but not limited to, one or more of the following: the Internet, a local area network (“LAN”), a wide area network (“WAN”), a wireless (e.g., ATM) network, a logical network within a single computer, some other form of programmatic communication such as inter-process communications or dynamic link libraries, or any combination thereof. Client 6 is preferably a personal computer (“PC”) or similar data processing device. Client 6 includes network interface 11 for interfacing to network 10, display screen 12 for displaying information to a user, keyboard 14 for inputting text and user commands, mouse 15 for positioning a cursor on display screen 12 and for inputting user commands, disk drive 16 for reading from and writing to floppy disks installed therein, and CD ROM drive 17 for accessing data stored on CD ROM. Close up view 18 shows the internal structure of client 6. Client 6 includes memory 19, which is a computers readable medium, such as a computer hard disk, for storing information. In the preferred embodiment memory 19 stores operating system 20, applications 21, and data 22. Microsoft Windows 2000 is one operating system that may be used with the invention; however, the invention is not limited to use therewith.

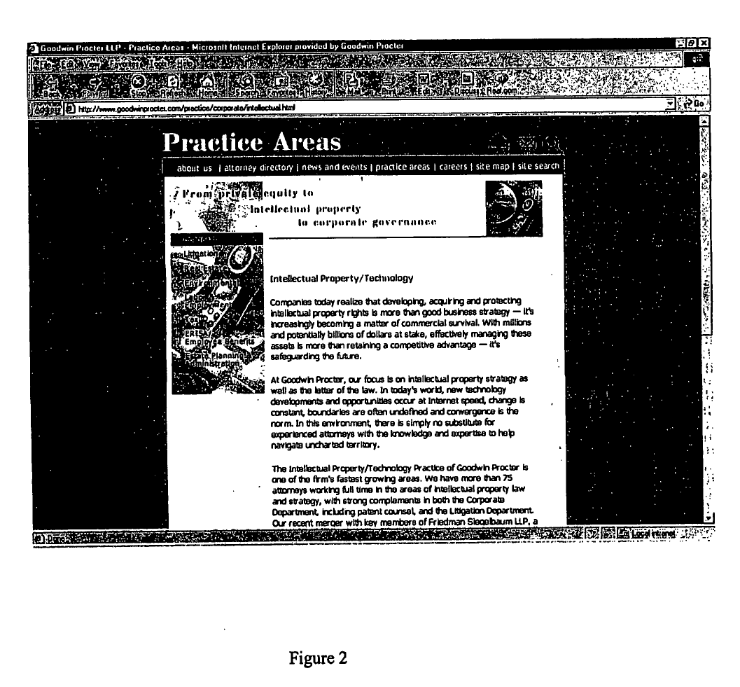

Applications 21 include Web browser 24, among others. An example of a Web browser that may be used with the invention is Netscape™ Navigator Web browser 24 displays a graphical user interface (“GUI”) to a user, through which the user may access information via the Internet (e.g., Web sites, individual Web pages, etc.). An example of such a GUI is shown in FIG. 2. Client 6 also includes display interface 26, keyboard interface 27, mouse interface 29, disk drive 20 interface 30, CD ROM drive interface 31, computer bus 32, RAM 34, and processor 35. Processor 35 preferably comprises a microprocessor or the like for executing applications, such as those noted above, out of RAM 34. Such applications, including browser 24, may be stored in memory 19 as noted above or, alternatively, on a floppy disk in disk drive 16 or CD ROM in CD ROM drive 17. In this regard, processor 35 accesses applications and data stored on floppy disk via disk drive interface 30 and accesses applications and data stored on CD ROM via CD ROM interface 31. Web server 9 may comprise a computer having features similar to client 6 for providing remote access to the Web site of an organization. Web server 9 is connected to other computers (not shown) in the organization via LAN 36 (or network 10). Web server 9 is also connected to certification server 7 via network 10 or other medium. Web server likewise includes a processor 23 and a memory 28, among other things, as shown in close up view 13.

Stored in this memory is assembly engine 25 and Web page elements 33. Assembly engine 25 is a program that is executed by processor 23 to assemble Web pages. More specifically, a single Web page may be composed of a plurality of static and dynamic elements, such as images, applets, text, sound, other Web pages, etc. In response to requests received from client 6, assembly engine 25 retrieves those elements (e.g., from memory 28) and combines them in a predetermined manner so as to form the Web page. Representative examples of commercially available assembly engines that may be used in connection with the present invention include ATG Dynamo, Servlets, JSP and ASP Certification server 7 likewise preferably comprises a computer having features similar to client 6. As shown in close up view 38, certification server 7 includes, among other things, memory 39 for storing both applications and certification information 48 which includes the manifests described below. Memory 39 may include one or more memory devices, such as a computer hard disk, redundant array of inexpensive disks (“RAID”), optical disk drive, and the like. Processor 40 is also included on certification server 7 so as to execute applications stored in memory 39 and to provide the resulting output to the network. Among the applications stored in memory 39 is certification engine 41. Certification engine 41 comprises computer executable code that runs on certification server 7 to certify Web pages and other dynamic pages based on their content and/or certification information stored in their elements. Certification engine 41 also organizes sets of Web pages into plural zones based on their levels of certification, the type of information contained therein, or the like, as described in more detail below. It is noted that certification server 7 and Web server 9 may be one in the same; however, since this is not a requirement, the more general case of separate Web and certification servers is depicted in FIG. 1. For that matter, the invention may also be implemented, in its entirety, on a single computer. That is, the functions of client 6, certification server 7 and Web server 9 (or its equivalent) may be implemented on a single computer.

Functional Architecture

The architecture of the present invention is composed of several major parts that fit together to provide a comprehensive trust solution for B2B marketplaces. While a described embodiment provides for content to be digitally signed as indicated, it is also contemplated that the invention can be implemented utilizing the same functions, processes, and data without digital signing.

The components include:

The Trust Warehouse: A comprehensive database of corporate profiles containing a combination of 3rd party data feeds, self disclosure by businesses, user feedback, and historical transaction information. This database is the source for corporate profiles that are shown via TrustWatch, within marketplaces, and other users of the data.

TrustWatch: A downloadable client program that can be enabled to hold the private keys of business representatives, displays True Credentials, detects embedded XML signed content, detects XML signature requests, facilitates signing and verifying of digitally signed content, and provides facilities for saving and retrieving locally stored digitally signed content.

Trust Administrator Enrollment and Administration services: A web based destination for a business's designated Trust Administrator that allows the Trust Administrator to enroll, disclose information about the business, and to setup and manage representatives of the business. At enrollment the Trust Administrator is issued a digital certificate that is used to gain access to the Administrative section. Each representative is issued a key pair/digital certificate for digital signing.

True Record: A highly secure storage location for digital receipts (Digital Receipt Vault) and a process for dispute resolution. Content that has been digitally signed is securely transmitted to the Digital Receipt vault. Businesses can then receive a comprehensive view of the commitments made on their behalf. Mechanisms for using digital receipts in a dispute situation is provided. True Record could also include a record of what the business' True Credential looked like at a particular time such as when the other business agreed to do the deal.

Integrated Risk Management and Financial Services: Based on the context, such as amount, transaction type, industry, etc. the transaction is routed to an appropriate insurance and/or credit provider. The user is then given options for different insurance/credit combinations.

Electronic marketplace Administrator services: Web based destination for the electronic marketplace's designated administrator to customize.

Electronic marketplace Deployment Kit: A collection of tools, sample code, and executables provided to an electronic marketplace for enabling Trust Authority services.

The Trust Warehouse

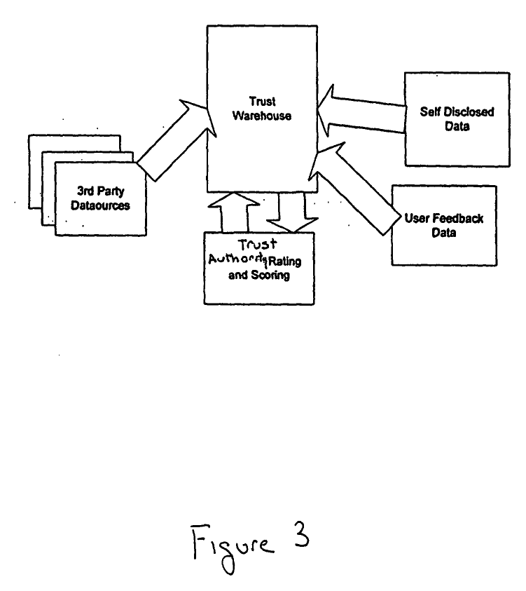

A basic component of the architecture of the present invention is the Trust Warehouse. The Trust Warehouse is an aggregation of information from many sources' influenced by the Trust Model™, that provide rich profiles of businesses as depicted in FIG. 3. This information is continuously growing but can be characterized by the following categories (these categories are not mutually exclusive).

Business Demographic Data: General information about a business such as number of employees, annual revenues, years in business, and so forth.

Credit scores: Ratings on a businesses ability to pay.

Business Policies: information about the policies of a business such as security policies, return policies, confidentiality policies, and so forth.

User Feedback: Information provided to the Trust Authority by users either at a transaction specific level or a general level.

Certifications Certification and seals earned by a company such as Better Business Bureau, ISO 900x, etc.

Self Disclosure data: Extensive information gathered directly from a company and updated on a regular basis.

Scoring and rating: Trust ratings as a quick way to assess the trustworthiness of a business.

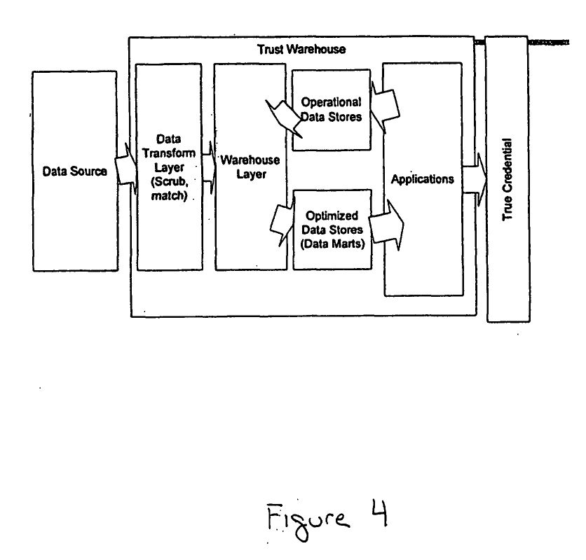

The Trust Warehouse, depicted in FIG. 4 has multiple layers, and pulls together this conglomeration of different data sources and provides it as a True Credential at the time and point of need.

Data sources can be kept independently within the Trust Warehouse and tied together with a Trust Identifier (TID), The TID is a unique number that binds all the known information for a particular enterprise across all data sources including external data extracts as well as internal systems.

Access to the Trust Warehouse is provided through HTML or an XML APl; On the 3rd party data XML API data is a subset of the overall information represented by a True Credential.

TrustWatch™

TrustWatch is a client side application that watches a browser session and provides True Credential information at the time and point of need. TrustWatch enables two key Trust Authority service offerings' True Identity for Site; and True Identity for electronic marketplaces.

With True Identity for Sites TrustWatch provides the user with information about the owner of the website currently being browsed, As a user encounters a new site TrustWatch looks up the site in The TrustWarehouse to determine if company/organization responsible for the site has registered. If the site is registered then a small window (trust display) is displayed in the bottom of the browser, The trust display shows the name of the company that is responsible for the website. By clicking on the trust display it is expanded to show the True Credential for the company, Even if a company has not registered with the Trust Authority, the trust display will show up if the browser and site are communicating via Secure Sockets Layer (SSL) as is common in an eCommerce transaction. This is due to the fact that an SSL certificate is available behind the scenes that gives the company's name and location, TrustWatch uses this information for the trust display and leverages information that is in the SSL certificate to display a subset of the True Credential information

With True Identity for electronic marketplaces TrustWatch offers secure digital signing of buyer and seller commitments, local storage of these digitally signed documents, verification of digitally signed documents, and True Credential display of signed commitments that are viewed on an electronic marketplace.

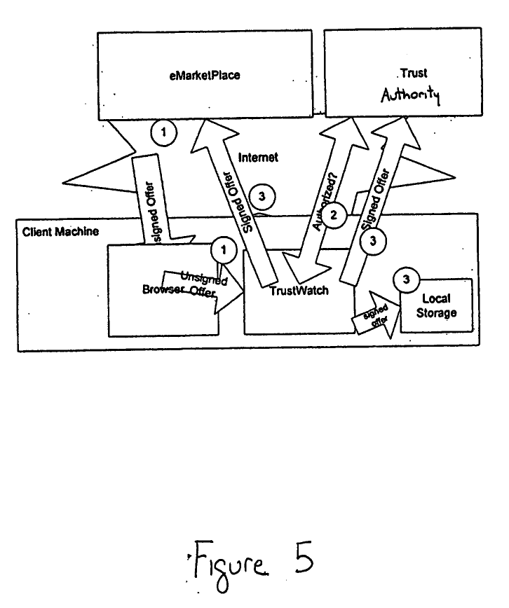

When an electronic marketplace is Trust enabled the option to digitally sign bids and offers is available. At the appropriate time the electronic marketplace transmits an unsigned offer/bid/RFP/RFQ/etc. formatted in XML embedded in the HTML of the electronic marketplace. TrustWatch watches for these unsigned offers, prompts the user to sign the offer, verifies that the user has the authority to make the commitment level represented by the author, digitally sign, the offer, store's the signed offer locally, transmits the signed offer in the Trust Digital Receipt vault (optionally), and finally transmits the signed offer to the electronic marketplace. See FIG. 5

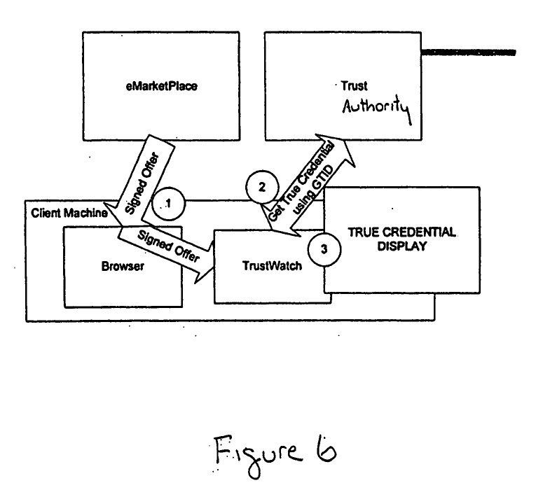

Viewing digital signatures and their corresponding True Credentials is a similar process. The electronic marketplace transmits the signed commitment embedded in HTML. TrustWatch detects the signed offer, verifies it and, assuming that the verification was successful Shows the True Credential of the signer's company The Trust identifier is stored in the digital certificate of the signer to facilitate requesting the TrueCredential of the signer. The process of verifying a digital signature is essentially the reverse of the original signing. A hash of the document that has been signed is compared to the decrypted hash in the digital signature. The digital signature is decrypted using the signer's public key. In the method of the present invention the public key is available via the signer's digital certificate which is referenced by and XML tag within the signature. See FIG. 6, TrustWatch displaying True Credentials

Trust Administrator Enrollment and Administration Services Enterprise, that sign up with the services of the present invention services can designate a Trust Administrator to represent the Enterprise. This Trust Administrator has the authority to 1) manage (add or remove) other Trust Administrators, 2) manage participants' (add, remove, or modify authority level), Participants are individuals with the authority to represent the enterprise within an electronic marketplace This usually means submitting officer, submitting bid etc., and 3) view reports.

Enrollment

The Trust Administrator will first go through an enrollment process to participate in present invention. This is accomplished by going to the Trust Administrator Enrollment page and filling out basic information about the Enterprise and the individual signing up. The enrollment process first generates the Trust Administrator's key pair, stores the private key in a local keystore, and sends the public key up to Trust Authority to be bundled into a digital certificate. A key pair is, the private and public key, used for digital signing and access to secure web pages. This is a Public Key Infrastructure (PKI) term. A digital certificate is a wrapper around a public key that has been digitally signed by a Certificate Authority (CA). The Certificate Authority guarantees, within the constrains of its Certificate Practice Statement (CPS), that the public key has been authenticated to represent an individual, a company, or the relationship between an individual and a company. Based on the initial information provided to the Trust Authority the Trust Administrator is informed of the documents that should generally be provided to verify the Trust Administrator's authenticity. Typically, depending on geographic area and other factors, the Trust Administrator will provide proof of the legitimacy of the company (i.e., letter of incorporation, etc.) and a letter of authorization from the company. These documents are faxed to the Trust Authority. Once the Trust Authority receives these documents and authenticates them the Trust Administrator receives an email, typically within 24 hours, giving him/her information on how and where to pick up their digital certificate.

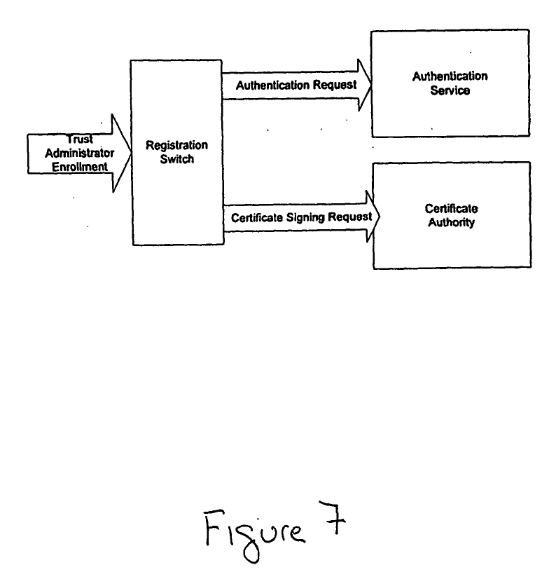

Based on the information provided initially by the Trust Administrator, the Trust Authority routes a request independently to an outsourced Authentication services and separately to an appropriate Certificate Authority (CA) to sign the certificate (See FIG. 7). This “registration switch” capability allows the Trust Authority to receive authentication services and certificate authority services from the most appropriate companies based on the context. The term “registration switch” is used in relation to the Registration authority concept in traditional public key infrastructure terminology, a Registration authority has the right to do the registration aspects of issuing a digital certificate under strict guidelines for a Certificate Authority by having a registration switch the Trust Authority will be able to front-end multiple Certificate Authorities based on criteria such as country

After the Trust Administrator is authenticated he/she is emailed a unique URL to pick up his/her digital certificate The Trust Administrator goes to the site and downloads the certificate to a keystore on their machine. This certificate gives the Trust Administrator access to the Trust Authority pages on the Trust Authority website

While the authentication of the Trust Administrator is a rigorous process it is the basis of making the rest of the process much simpler. The Trust Administrator can now set up participants (or other Trust Administrators) quickly and easily

Setting Up Participants

Using the digital certificate received in the process described above the Trust Administrator can now set up participants. This is accomplished by navigating to the main Trust Administrator page and clicking on the Manage Participants link. In this section the Trust Administrator can add participants, remove participants, or modify a participant's authority to add participants, remover participants, or modify a participant's authority. To add a participant the Trust Administrator first enters information about the participant, including authorization for each electronic marketplace. The Trust Administrator is then given a PIN that should be securely provided to the participant. The participant is emailed a notification that the Trust Administrator will be Contacting him/her with a PIN number and the participant is provided a URL to pick up his/her certificate. When the participant arrives at the URL a participant signup process is invoked which generates a private key for the participants stores it in a local keystore, and submits a certificate signing request to the Certificate Authority This happens as a continuous process with the result being a private key and a digital certificate for the participant stored in the participants local keystore. Once this has occurred the participant is ready to digitally sign commitments within electronic marketplaces.

Managing Participants

At any time Trust Administrators can modify or remove Panticipants. Modification involves adding o removing electronic marketplaces or changing the authorization level of a participant within an electronic marketplace. Modifications take effect immediately

Viewing Reports

The Trust Administrator at any time come and see a variety of reports representing activity that has occurred on behalf of his/her company.

Managing Enterprise Self Disclosure

A responsibility of the Trust Administrator is managing the disclosure of the Enterprise specific information that the Trust Authority keeps about an Enterprise. Enterprise disclosure occurs via the Trust Advisor an interactive, dynamic questionnaire, that asks questions pertinent to a particular Enterprise. For example, if a company is in the plastics industry a different set of information would be gathered that a company in the steel industry.

View True Credential

At any time a Trust Administrator can view the True Credential for the company he/she represents. This will not necessarily be the exact way a viewer will within an electronic Marketplace or other context for viewing a True Credential will appear since True Credentials may be customized for a particular context. All True Credential data that is in the Trust Authority databases regarding the Trust Administrator's company are shown in this view.

Data Dispute Resolution

In certain circumstances a Trust Administrator will want to dispute the accuracy of data that was sourced by some data source other that the Trust Authority. This can be accomplished under specific guidelines.

True Record

The True Record service of the present invention consists of two primary functions: 1) highly secure storage of digital receipts for later retrieval and 2) an interface to dispute resolution services based on a True Record.

Whenever a Trust Authority digital signature is created or encountered by a TrustWatch user there is an option of transmitting this securely to a digital receipt vault. The digital receipt vault is a highly secure location that enables the Trust Administrator and participant, to view and download the commitments made on their behalf. These commitments are non-repudiable documentation of these commitments and can be used in the case of a dispute.

The Trust Authority also provides interfaces to 3rd party dispute resolution services.

Integrated Risk Management Services

The present invention can also provide, multiple risk management service option, including insurance, credit, and fulfillment services. These services vary based on the context of the electronic marketplace, the specific profile of the businesses involved in a transaction, and specific aspect, of the transaction. Blanket insurance can be offered for all transactions, this presents the users with an additional means of guaranteeing identity of a party in a transaction. Typically, a warranty or transaction insurance can be issued to the other party to the transaction based on the (prior) authentication process.

Electronic Marketplace Administrator Services

At any time electronic marketplace Administrators can access the Trust Authority electronic marketplace Administrator Home page to customize and assess the activity at their site. An electronic marketplace Administrator can control aspects of what constitute, a True Credential down to the field level in the context of their electronic marketplace. The present invention can also be utilized in environments other than an electronic marketplace. For example, the invention could take the form of a consumer/business surfing to a seller's Web site using the Trust Authority “True Credentials” icon on it. In an exemplary transaction, the consumer could click on the icon (OR use a client-based Trust Watch) to view the authentication, self-disclosed, site's SSL cert info, and/or third party data package as displayed from the Trust Authority's data center, a third party source, using the Web Site Identity Assurance technology described in co-pending application Ser. No. 10/039,986 entitled Web Site Identity Assurance, which is incorporated herein by reference. This could be utilized by a third party Web site that offers potential customers—using the Trust Authority as trusted third party for display of confirmed and unconfirmed info about a particular Web site.

The Customer Factory Object

One of the most significant architecture questions for trust authorities has been how customer information that exists in a variety of data sources such as external extracts (InfoUSA, Veritas, Network Solutions, etc.) and business systems (CRM, Billing, Sales, etc) will be cross-referenced and managed. For example, how will a trust authority optimize two critical but seemingly contradictory requirements? First, the customer is integrated and seen whole across multiple disparate data sources. Second, for a variety of reasons, the data is kept well cordoned and independent. The present invention provides for abstracting this problem in a set of two major objects and an interface; 1) the CustomerFactory object, 2) the Customer object, and 3) the DataSource interface. These objects interact to provide a flexible strategy for creating, finding, and inter-relating customer information across many disparate data sources.

The present invention provides a pattern and foundation for identifying and managing customer information across multiple data sources.

An aspect of the present invention is to provide a solution of how to bring together a wide variety of data sources containing information about customers into an understandable whole while maintaining the contractual obligations and integrity required by a specific data source.

The term customer is loosely herein to mean any entity that would be a subject of information in a data source. The primary short-term example is an Enterprise, with respect to business information, but could also be individuals, associations, etc. This is in contrast to defining a customer as some entity who has purchased a service from a trust authority and is paying money.

At first glance, one might imagine that a trust authority would take the many different data extracts and data from internal systems, merge them together, and create a clean, single data structure combining all the information we have for a customer. Due to contractual constraints on externally extracted data (for example, some customers do not allow blending of its data with several named data sources), as well as the trust authority strategy for using application service providers for internal operational systems (for example, SafeHarbor can be used for its CRM and MetraTech for its billing system), this enterprise customer data model is not feasible. Each data source will have contractual constraints on its usage.

Instead, a management strategy is required to understand all of the places a customer is represented. Customer information will live in its silos but be pre-matched and cross-referenced with unique identification tying all this customer information together. An abstraction layer as described herein will make it straightforward to obtain customer information across multiple data sources, add new customers, obtain profiles, etc. The result will allow integrated viewing and manipulation of a customer as a whole while preserving the integrity of the underlying data source information. Note that this does not mean that specific optimized data structures that bring together data from multiple sources will not exist, they will. A common pattern for data sources may be that they are extracted into a data source specific area of the data warehouse and then, as needed, merged into “data marts” (data structure/databases that are optimized for certain types of access.

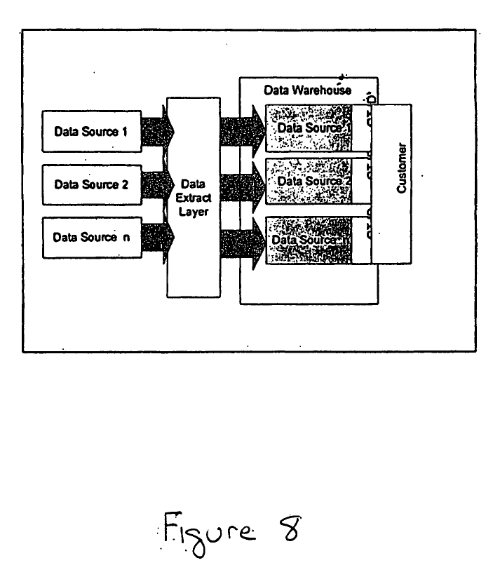

FIG. 8 shows how data sources are brought through a Data Extract Layer (where scrubbing and matching occurs) but remain independent within the Data Warehouse. This is accomplished by establishing a trust authority identifier (TID) for each customer that is used to cross reference the customer across data sources. The customer object, described in detail herein, provides an abstract view of the customer, while providing access to these multiple data sources.

In FIG. 8 many data sources are brought together into the trust authority Data Warehouse but may maintain independent structures tied together by the TID. The customer object provides an integrated method for accessing this customer data.

In an exemplary embodiment, the TID contains no information itself. It is used to associate information between information sources.

The concept of a Factory object comes from the Factory design pattern as known in various design pattern books. The Factory design pattern is used when there is a set of data, typically in some serialized form (like a file or XML structure), which needs to create an instance of some underlying object. In the present invention, the Customer Factory object manufactures instances of customer objects from the data passed to it from a data source.

1. Data Source Independence—In an embodiment the architecture will support the existence of multiple independent data sources. For external extracts, this is primarily due to the contractual constraints and tracking purposes. For internal systems, this is due to application service provider (ASP) systems for Customer Relationship Management, Billing, Sales, etc.

2. New Data Source—In an embodiment the architecture will support addition of new data sources.

3. New Data within Data Sources—In an embodiment the architecture will support continuous addition of new instances of data within a particular data source (e.g., new companies showing up in customer data).

4. New Data fields within Data Sources—In an embodiment the architecture will support fields being added within Data Sources.

5. In an embodiment an “API” or interface of some sort will be available to external systems and internal systems that house trust authority customer data. This API should allow all of the necessary management of the overall trust authority customer cross-references. For example, functions to add customers, and obtain trust authority unique customer identification, as set forth will exist.

6. Support modification of data within Data Sources—In an embodiment the architecture will support continuous updates of data within a particular Data Source, including the data that is used to determine matches in the Data Source.

Architecture Description

The approach in the present invention for addressing this problem involves two major objects and one interface that interact to provide an integrated strategy for managing information about customers across multiple data sources. These three objects are: 1) the CustomerFactory Object (see below for detailed description), 2) the Customer Object (see below for detailed description), and 3) the Data Source Interface, that must be implemented by al Data Source objects (see below for detailed description).

The CustomerFactory Object responds with a customer object when passed a data structure containing customer information. To accomplish this it references at least one of the potential data sources that a customer can participate in within the trust authority. If it finds a match in one of the data sources, it returns the matched customer object. If it does not find a match in any of the data sources, it creates a new customer object by calling the customer constructor and returns that customer object.

The customer object represents an individual instance of a customer. A customer object knows all of the data sources where it exists. Once a customer object knows what record in a Data Source it is associated with, it refers to the same record in the Data Source. In an embodiment, it also supports different types of queries to it (e.g. getProfile( )) which is not addressed in great detail in this application. In other words, once a mapping is established between a TID and a key in the Data Source, that mapping persists forever.

The Data Source Interface is a collection of methods that any specific data source object or object representing an external system housing customer information must implement. (This may be a proxy object within the trust authority architecture that will represent the external system. Any interactions between the external system and the trust authority systems would go through this object. This object would implement the Data Source interface but can have other interfaces and/or methods, as well.) One of the key things a Data Source will know how to do is determine if it has a matching customer from data that is passed to it. It also supports queries to it (which is not addressed in detail here).

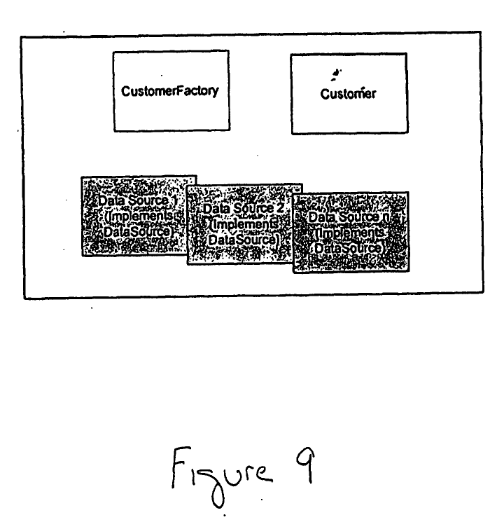

FIG. 9 shows major objects described in this application.

Scenarios

Described below is an example of how a customer would be created in reference to the Customer Factory architecture. In the present example, an external system, such as a Customer Relationship System, has received input of a new customer and needs to assure that this customer is cross-referenced correctly with other information that the trust authority has on that customer. The following is the scenario for how this would work. This is not an exact scenario for the CRM of the present invention as is provided for illustrative purposes only. Note that the scenario for obtaining customer information from an external extract (Scenario 2) is similar.

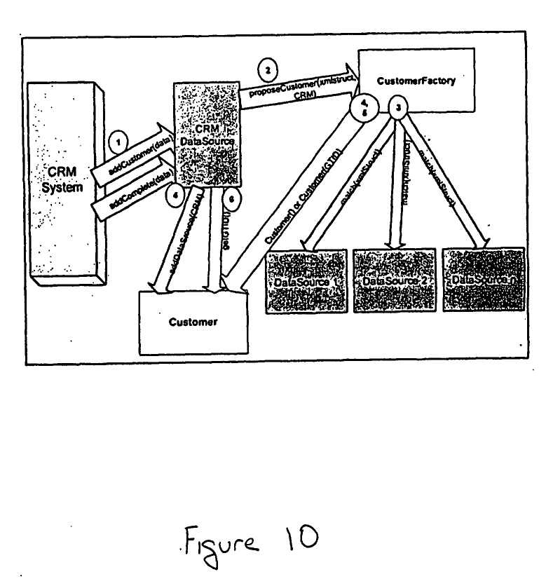

Scenario 1—CRM New Customers (See FIG. 10)

1. A customer service representative has entered information on a new customer within the CRM system. The CRM system calls its proxy object the CRM Data Source object with addCustomer( ). This may be a proxy object for the CRM system that implements the Data Source interface. An additional interface may be implemented specifically for data sources that represent external systems.

2. The CRM Data Source object calls the Customer Factory object's proposeCustomer method passing an XML structure with the customer information unique to the CRM.

3. The Customer Factory proposeCustomer method first determines whether this customer already exists in one of the possible trust authority data sources. To accomplish this it iterates through at least one of the data sources to determine if there is a match.

4. If a match is found:
a. the proposeCustomer method calls the customer constructor passing the TID as an argument. This method returns a customer instance proposeCustomer then returns this customer instance.

5. If no match is found:
a. the customer constructor is called with no argument.
b. the customer constructor generates a new TID, does other initialization, and returns a customer instance.
c. this Customer instance is returned to the CRM system.

6. The CRM system now has a new Customer object. It can query the Customer to get its TID, Name, etc. Note that it may record the mapping between the TID and the CRM system's keys for identifying the record. This may be done so that the CRM system will return this same customer when proposecustomer( ) asks the CRM Data Source.

7. When the CRM has successfully inserted the customer notifies the Customer object that a new data source knows about it. It does this by calling the addDataSource( ) method on the Customer. At this point the CRM has the appropriate TID for this Customer and the trust authority knows that the CRM contains information on this Customer.

FIG. 10 depicts Scenario 1, CRM new customer.

Scenario 2—New Customer

This scenario is very similar to the previous; instead it is being invoked by a different type of data source. To setup the scenario imagine that the trust authority monthly update from the customer is processing a feed from the customer and each record is marked as an add, change, or delete record.

1. The customer batch processing program receives an “add” record. It invokes the addcustomer( )method within the customer proxy object within the trust authority architecture. The customer object implements the Data Source interface. The addCustomer( ) method may be specific to the Data Source and may not be part of the Data Source interface.

2. The customer Data Source object in turn invokes the CustomerFactory.proposeCustomer( )method.

3. The proposecustomer( ) method iterates through all of the possible data sources invoking their match( ) method.

4. If a match is found:

a. The proposeCustomer method calls the Customer constructor passing the

TID as an argument. This method returns a Customer instance. proposeCustomer then returns this Customer instance

5. If no match is found:

a. The Customer constructor is called with no argument.

b. The Customer constructor generates a new TID, performs other initialization, and returns a Customer instance.

c. This Customer instance is returned to the InfoUSA system.

6. The customer system now has a new Customer object.

Scenario 3—Deleted Customer

There are two exemplary sub-scenarios for potential information sources will deliver updates to the trust authority. Either the Data Source will explicitly notify that the Customer is deleted (via a “delete record”), or the deletion will be implicit (a new data set with the Customer omitted).

In the first case,

1. The customer batch processing program receives an “delete” record. It invokes the deleteCustomer1(ABANumber) method within the customer proxy object within the trust authority architecture. This method may be specific to the Data Source and may not be part of the Data Source interface.

2. The customer DataSource object looks up the TID for the specific customer using the ABA number. It then instantiates a Customer instance by calling the customer constructor using the TID argument.

3. The deleteDataSource method is called for the Customer object.

4. The customer Data Source now has no association to the Customer object.

In an exemplary embodiment, Data Sources will support explicit deletion. If not, the customer batch-processing program will iterate over all Customers for which customer is listed as a Data Source, and delete the Data Source.

Scenario 4—Add a Data Source

This is similar to adding a new entry to the Data Source (Scenario 2). Follow the procedure for each entry in the new Data Source.

Scenario 5—Delete a Data Source

This is similar to deleting each of the Customers represented by the Data Source. The entire Data Source content is treated as a set of “delete” records.

Scenario 6—“Matching” Data in a Data Source is Changed

Once a TID is associated with an object, the association should be maintained, even if the company information in the Data Source changes. An exemplary instance is when the information that is used to determine a match between the DataSource and potential customer information.

An example is when a trust authority has changed its location twice since inception. Many information sources still record that the trust authority is located in, for example, Lake Oswego. However, the current business location is now, for example, Portland. If the company name, city and state are being used to match up the “trust authority” in Data Sources, there is a risk of identifying that there are two such companies (one that matches against “trust authority/Portland/Oregon” and one that matches against “trust authority/Lake Oswego/Oregon”.

Additionally, changes like the propagation of the name change may occur at different rates in the data sources. In fact, the change of address might never be reflected.

Class/Interface Descriptions

CustomerFactory Objects

The CustomerFactory Object is the primary Object that implements the trust authority business rules for identifying and creating new Customers. Note as described above, the term customer is used loosely here to mean any entity (company, individual, etc.) that is an identifiable subject of a data source. Ultimately it includes both existing and potential Customers. This is not an exhaustive list of the methods associated with these objects. For example, administrative methods for deleting a DataSource is not included.

TABLE 1

| Scope | Return Type | Method Name | Description |
|---|---|---|---|
| Public | CustomerFactory | CustomerFactory( ) | Initializes CustomerFactory object. |
| Public | Customer | proposeCustomer(xmlStruct, DataSource) | This method is called by any data source that may have |
| | | | customer data and needs its identifier (or customer |
| | | | instance). Using the data passed in xmlSruct the |
| | | | proposeCustomer method attempts to match against all of the |
| | | | possible GeoTrust DataSources. If it finds a match it |
| | | | instantiates an instance of the Customer and |
| | | | returns it. If it does not find a match it creates a new |
| | | | Customer instance and returns it. |
| Public | Enumerator | getDataSources( ) | Returns an enumerator to a collection of all of the |
| | | | possible data sources that a Customer can participate in. |

Customer Object

The Customer Object represents an instance of a the trust authority Customer. Its function is to be an abstraction across a variety of underlying data sources.

TABLE 2

| Scope | Return Type | Method Name | Description |
|---|---|---|---|
| Public (static) | Customer | Customer(GTID) | Creates and initializes a Customer object instance for |
| | | | the customer with this GTID. |
| Public (static) | Customer | Customer( ) | Creates and initializes a Customer object instance for |
| | | | the customer with a unique GTID. |
| Public (static) | Customer | getCustomer(GTID) | Returns the Customer associated with a specific GeoTrust |
| | | | identifier |
| Public | Long | getGTID( ) | Returns the GeoTrust Unique identifier for this Customer |
| Public | Enumerator | getDataSources( ) | Returns an enumerator on a collection of the data |
| | | | sources that this Customer participates in. |
| Public | void | addDataSources(DataSource) | Adds a DataSource to the collection of DataSources that |
| | | | a Customer participates in. This method will typically be |
| | | | called after a DataSource has succesfully added Customer |
| | | | information into its own data store. |
| Public | Void | deleteDataSource(DataSource) | Remove the DataSource from the collection of Data Sources |
| | | | that a customer participates in. This method will typically |
| | | | be called when a Data Source is updated, and a Customer's |
| | | | record has been removed. |
| Public | XMLStruct | getProfile(format, exclusions) | Returns XML structure representing the entire profile (all |
| | | | known information) across data sources minus exclusions. |
| Private (static) | long | generateID( ) | Returns a valid, unique number to use as the ID for a |
| | | | Customer. |

DataSource Interface

In an embodiment all data sources implement this interface. A data source represents some internal or external information keyed to a particular customer. Examples of data sources are customers (external information) and the trust authority CRM (internal information).

TABLE 3

| Scope | Return Type | Method Name | Description |
|---|---|---|---|
| Public | Customer | match | DataSource uses xmlStruct to |
| | | (xmlStruct) | make its best attempt to match |
| | | | the incoming customer informa- |
| | | | tion to an existing customer |
| | | | that it knows about. |
| Public | Enumerator | getFields | Returns an enumerator on a |
| | | (Customer) | collection of all of the |
| | | | fields related to a specific |
| | | | Customer. |

XMLMatching Object

The references to xmlstruct in the matching may be defined as an object in its own right.

DataSources Object

There may be a need for an object which records all known data sources, separate from the CustomerFactory object. There may be data sources that ultimately do not participate in any kind of “customer” relationship. There is also likely to be reasons to keep track of these objects for participation in other Trust authority server activities (e.g., integration with business systems, like billing).

Logical Architecture

The techniques described here are not limited to any particular hardware or software configuration; they may find applicability in any computing or processing environment. For example, functions described as being performed by a server can be distributed across different platforms. Moreover, the techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Thus, the foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1) A method for providing a user with confirmation of the identity of a transaction partner comprising the steps of:
gathering a plurality of business credentials for at least one transaction partner having significance to a defined customer,
indexing said business credentials for an electronic database,
evaluating the value of each of said business credentials to said defined customer,
providing electronic access to said database,
generating at least one report summarizing the business credentials of said at least one transaction partner.

2. A method for providing confirmation of the identity of a potential party to a transaction, comprising the steps of:
gathering a plurality of relevant information relating to at least one potential party to a transaction;
indexing the plurality of relevant information for an electronic database;
evaluating a value of each of the plurality of relevant information;
providing electronic access to the electronic database; and
generating at least one report including at least one portion of the plurality of relevant information.

3. The method according to claim 2, wherein the relevant information includes business information.

4. The method according to claim 2, further comprising the step of assigning a value to each of the plurality of relevant information.

5. The method according to claim 2, wherein the at least one portion of the plurality of relevant information includes a summary of business credentials of the at least one potential party to a transaction.

6. The method according to claim 2, wherein the transaction is an on-line auction.

7. The method according to claim 2, wherein the transaction is an on-line purchase.

8. A method for providing confirmation of the identity of a potential party to a transaction, comprising the steps of:
gathering a plurality of relevant information relating to at least one potential party to a transaction;
coupling a portion of the plurality of relevant information to at least one electronic file, using a digital signing process;
providing access to the portion of the plurality of relevant information via the at least one electronic file; and
verifying that the at least one electronic file was not altered subsequent to the digital signing process.

9. The method according to claim 8, wherein the at least one electronic file includes content data.

10. The method according to claim 8, wherein the at least one electronic file includes data relating to a web page.

11. The method according to claim 8, wherein the at least one electronic file includes data relating to a bid.

12. The method according to claim 8, wherein the at least one electronic file includes data relating to an offer.

13. The method according to claim 8, wherein the relevant information includes business information.

14. The method according to claim 8, wherein the digital signing process includes committing to an offer to sell.

15. The method according to claim 8, wherein the digital signing process includes committing to an offer to buy.

16. The method according to claim 8, further comprising the step of securely storing the electronic file.

17. The method according to claim 8, further comprising the step of generating at least one report including at least one portion of the plurality of relevant information.

18. The method according to claim 8, further comprising the step of promoting the transaction.

19. The method according to claim 18, wherein the promoting includes offering at least one service relating to the transaction.

20. The method according to claim 19, wherein the at least one service is financing of the transaction.

21. The method according to claim 19, wherein the at least one service is shipping.

22. The method according to claim 18, wherein the promoting includes offering at least one good relating to the transaction.

23. The method according to claim 22, wherein the at least one good is packaging.

24. The method according to claim 18, wherein the promoting includes offering at least one benefit relating to the transaction.

25. The method according to claim 24, wherein the at least one benefit is insurance.

26. An electronic file containing relevant information relating to the confirmation of the identity of a potential party to a transaction, obtained by the steps of:
gathering a plurality of relevant information relating to at least one potential party to a transaction;
coupling a portion of the plurality of relevant information to at least one electronic file, using a digital signing process;
verifying that the at least one electronic file was not altered subsequent to the digital signing process.

27. A computer system for providing confirmation of the identity of a potential party to a transaction, comprising:
a receiver, the receiver receiving relevant information relating to at least one potential party to a transaction;
a processor coupled to the receiver, the processor indexing the relevant information for a database, evaluating a value for each portion of the relevant information and generating at least one report including at least one portion of the relevant information;
a storage device coupled to the processor, the storage device storing the database; and
an interface, the interface coupled to the storage device and the processor, the interface providing access to the database.

28. The computer system according to claim 27, wherein the receiver is a modem.

29. The computer system according to claim 27, wherein the receiver is a data interface.

30. The computer system according to claim 27, wherein the interface is a keyboard.

31. A computer system for providing confirmation of the identity of a potential party to a transaction, comprising:
a receiver, the receiver receiving relevant information relating to at least one potential party to a transaction;
a processor coupled to the receiver, the processor coupling a portion of the relevant information to at least one file using a digital signing process, and verifying that the at least one file was not altered subsequent to the digital signing process;
a storage device coupled to the processor, the storage device storing the file; and
an interface, the interface coupled to the storage device and the processor, the interface providing access to the portion of the relevant information via the at least one file.

32. The computer system according to claim 31, wherein the interface is a keyboard.
